(19) United States
(12) Patent Application Publication
(10) Pub. No.: US 2017/0021303 A1
(43) Pub. Date: Jan. 26, 2017

(54) Natural Gas Processing for Reduction in BTX Emissions and Energy Efficiency

(71) Applicant: Gene Randal Olivier, Eunice, LA (US)

(72) Inventor: Gene Randal Olivier, Eunice, LA (US)

(21) Appl. No.: 14/807,017

(22) Filed: Jul. 23, 2015

(51) Int. Cl. B01D 53/14; B01D 53/18

(52) U.S. Cl. CPC B01D 53/1493; B01D 53/1412; B01D 53/1425; B01D 53/1487; B01D 53/18; B01D 2252/2023

(57) ABSTRACT

An energy-efficient continuous process (and apparatus) that eliminates or reduces the emission of BTX into the environment during a process of dewatering natural gas using glycol. The apparatus includes an absorption tower to dewater the natural gas, and a glycol dewatering unit that includes a reboiler and a distillation column. Overhead vapor, including steam and BTX vapor, from the distillation column is condensed in an air-cooled heat exchanger. The liquefied BTX may be separated for fuel, sale or other disposal. A fan is positioned to force or induce air to flow through the air-cooled heat exchanger. The fan may be driven by a hydraulic motor by pressure of a glycol process stream. In another embodiment, the overhead vapors from the distillation column are cooled against a stream of water-containing glycol being charged to the glycol dewatering unit thereby preheating this stream and reducing energy input to the reboiler.

### BACKGROUND

1. Field of the Invention

The inventions relate to the de-watering of natural gas, and more particularly, relate to enhancements that improve the energy efficiency of the de-watering apparatus and processes while also reducing or eliminating the release of benzenes, toluenes and xylenes (“BTX”) into the environment.

2. Description of the Related Art

It is conventional in natural gas production to remove water from the gas. This water naturally occurs and is produced with the gas, in the continuous gas production stream. Removal of the water prevents or minimizes corrosion in the gas transportation pipelines and associated equipment, and avoids issues that could arise if temperatures were to drop below freezing point causing the water to convert to ice. In addition, certain “aromatic” hydrocarbon chemicals, such as benzenes (including ethyl-benzene), toluene and xylene, may also be present in the natural gas. These aromatics, generally known as “BTX” or “BETX” in the industry, have been identified as potentially hazardous to human health and release of these into the environment must be avoided.

Equipment is often located at the natural gas production site to de-water the gas. Briefly, in general, the continuous gas de-watering process has equipment that includes an absorption tower where the produced natural gas is contacted with a moisture-absorbing chemical liquid, like ethylene glycol (hereinafter referred to as “glycol”) to absorb moisture from the gas. The glycol is re-constituted by flashing off the absorbed water as steam in a flash separator that operates in combination with a reboiler, which uses on-site produced natural gas as heating fuel. The reconstituted glycol exiting the reboiler, having most of the absorbed water removed, can then be recycled to the absorption tower for re-use in moisture absorption.

An exemplary and illustrative process flow diagram of the de-watering equipment is shown in FIG. 1. In the process illustrated, the raw natural gas in line 12 is treated and exits the process as de-watered natural gas in stream 19. The water removed from the natural gas is sent to safe disposal, and any BTX removed may be recovered for use as fuel in the process. In more detail, the raw natural gas in line 12 enters near the base of an absorption tower 20, while glycol in line 14, having been preheated in glycol preheater 22, enters at the top of the absorption tower 20. In the absorption tower 20 there is counter-current contact between the incoming raw natural gas and the glycol. This contact allows the glycol to strip water (and some BTX) out of the raw natural gas to produce a dried natural gas that exits from the top of tower 20 in line 18. The gas in line 18 is relatively cooler than incoming glycol, and heat is transferred to the gas from the glycol (in line 14) in glycol cooler 22. Thus, cooled glycol exits the glycol cooler 22 in line 15 and is routed to the top of absorption tower 20, while natural gas, having been dewatered and warmed, exits the glycol cooler 22 in line 19 for routing to storage, transportation, and/or sale.

On the “glycol-handling” side of the process, the water-containing glycol exiting the absorption tower 20 is dewatered and put in condition for recycling to the absorption tower 20. Upon exiting from near the base of absorption tower 20 in line 16, the water-containing glycol which is under pressure, drives a hydraulic motor 32, which in turn drives the glycol transfer pump 34 that pumps the glycol to the absorption tower 20. The water-containing glycol exits the hydraulic motor 32 in line 17, and enters the glycol preheat exchanger 40. In the glycol preheat exchanger 40, the water-containing glycol is heated by taking heat from hot glycol in line 58, that has been heated in the reboiler 54, as explained later. The heated water-containing glycol exits the glycol preheat exchanger 40 in line 18 and is charged to a flash separator 45. Here, BTX entrained in the glycol flashes off as vapor in line 46, and can be routed for use as fuel in the process, and any excess may be vented to atmosphere. The liquid fraction exiting the flash separator 45 is charged to a glycol de-watering combination apparatus 50 that includes a reboiler 54 and a distillation column 52. The combination apparatus separates the glycol from the water it absorbed in absorption tower 20 from the raw natural gas. Thus, de-watered glycol exits in line 58 from the base of the reboiler 54, which is heated by natural gas, and water in the form of steam exits in line 56 from the top of the distillation column 52. The steam and any BTX vapor in line 56 enters an overheads condenser 60, in the form of a water-cooled heat exchanger, and loses heat and latent heat to the water entering the condenser 60 via line 64. The condenser has vent that allows the release of non-condensable gasses and BTX via line 62 into the atmosphere. The condensed water and liquefied BTX from the overheads condenser 60 in line 66 enters an overheads drum 70 that has a vent 72 for releasing non-condensable gasses and BTX vapor to the atmosphere, and an exit line 74 to divert the condensate water that includes liquefied BTX for disposal.

The above-described process and apparatus is typical of existing natural gas de-watering systems, albeit that some may depart from the system in some features. The apparatus is not designed to, and does not, significantly contain the release of BTX into the environment.

### SUMMARY

In an exemplary embodiment there is presented a continuous process apparatus for dewatering natural gas and reducing or eliminating release of benzenes, toluenes and xylenes into the environment. The process apparatus includes an absorption tower configured for continuous counter-current contacting therein of upward flowing natural gas containing water with downward flowing glycol to dewater the natural gas. The absorption tower has an exit stream of water-containing glycol that includes benzenes, toluenes, and xylenes. The apparatus also includes a glycol dewatering unit comprising a reboiler and a distillation column. The glycol dewatering unit is configured for continuously receiving from the absorption tower, via a conduit, a continuous stream of glycol containing water and benzenes, toluenes, and xylenes. The glycol dewatering is configured to remove water from glycol to produce a first stream, in a first conduit, exiting from the reboiler containing glycol that has a reduced water content, and a second stream, in a second conduit, exiting from a top of the distillation column, that comprises overhead vapor that includes steam, benzenes, toluenes, and xylenes. A condenser, in continuous fluid communication with the second conduit, receives the overhead vapor from the distillation column. The condenser includes an air-cooled heat exchanger sized and configured to condense the received overhead vapor including the steam, benzenes, toluenes, and xylenes to form a condensate. A fan is located relative to the air-cooled heat exchanger to force or induce air to flow through the air-cooled heat exchanger. The fan may be driven by a hydraulic motor that is driven by glycol exiting from the absorption tower. The apparatus includes a condensate-receiving overheads drum in continuous fluid communication with the air-cooled heat exchanger to receive and contain the condensate from that includes liquefied benzenes toluenes and xylenes. As a consequence in the apparatus, under normal operating conditions, 95% to 99.9% of benzenes, toluenes, and xylenes separated from the natural gas are contained from the environment and are either used as fuel or processed for sale.

Optionally, the exemplary embodiment includes a hydraulic glycol transfer pump. The pump may be driven by a second hydraulic motor driven by glycol exiting from the absorption tower. The second hydraulic motor may be upstream or downstream of the hydraulic motor driving the fan.

Optionally, the process apparatus includes a control valve that controls a portion of the glycol exiting from the base region of the absorption tower to communicate via a conduit to the hydraulic motor of the fan of the air-cooled heat exchanger.

Optionally, the process apparatus includes a temperature-sensor controller that controls the portion of the glycol exiting from the base region of the absorption tower to communicate via a conduit to drive the hydraulic motor of the fan to achieve condensation of the benzenes, toluenes, and xylenes included in the overhead vapor.

In another exemplary embodiment, there is provided a continuous process apparatus for dewatering natural gas and reducing or eliminating release of benzenes, toluenes and xylenes into the environment. The process apparatus includes an absorption tower configured for continuous counter-current contacting therein of upward flowing natural gas containing water with downward flowing glycol to dewater the natural gas. The absorption tower has an exit stream comprising water-containing glycol and entrained benzenes, toluenes, and xylenes. The apparatus also includes a glycol dewatering unit comprising a reboiler and a distillation column. The unit is configured for continuously receiving water-containing glycol from the absorption tower and is configured to remove water from glycol to produce a first stream, in a first conduit, exiting from the reboiler containing glycol that has a reduced water content, and a second stream, in a second conduit, exiting from a top of the distillation column that comprises overhead vapor, where the overhead vapor includes steam, benzenes, toluenes, and xylenes. In addition, the apparatus includes a condenser in continuous fluid communication with the second conduit to receive the overhead vapor from the distillation column. The condenser includes a heat exchanger in fluid communication with a conduit carrying water-containing glycol that exited from the base of the absorption column. The heat exchanger is sized and configured to utilize the water-containing glycol that exited from the absorption column as a cooling and condensing medium to condense the overhead vapor from the distillation column to form a condensate that includes water, and liquefied benzenes, toluenes, and xylenes. The apparatus further includes an overheads drum in continuous fluid communication via a condensate conduit with the condenser to receive and contain the condensate. The condensate can be separated into water and benzenes, toluenes, and xylenes. The benzenes, toluenes, and xylenes can be used as fuel or can be sold. As a consequence in the apparatus, under normal operating conditions, 95% to 99.9% of benzenes, toluenes, and xylenes separated from the natural gas are contained from the environment and are either used as fuel or processed for sale.

Optionally, the process apparatus of includes a hydraulic glycol transfer pump driven by a hydraulic motor. The hydraulic motor may be driven by glycol exiting from the absorption tower. The hydraulic motor may be upstream or downstream of a conduit carrying glycol exiting from the absorption tower to the condenser.

An exemplary continuous process for dewatering natural gas and reducing or eliminating release of benzenes, toluenes and xylenes into the environment, includes the following steps. The step of continuous counter-current contacting of upward flowing natural gas containing water with downward flowing glycol to: (a) dewater the natural gas by absorbing the water in the glycol, and (b) remove benzenes, toluenes, and xylenes from the natural gas, to produce a water-rich glycol stream containing benzenes, toluenes, and xylenes, and a substantially water-free natural gas stream. In addition, the step of continuously stripping water from the water-rich glycol stream containing benzenes, toluenes, and xylenes to produce a first stream comprising glycol stripped of water, and a second stream, in vapor form, comprising steam and vapors of benzenes, toluenes, and xylenes. Further, the step of continuously condensing the vapor of the second stream to produce a liquid condensate of water and liquefied benzenes, toluenes, and xylenes. Whereby, during the continuous process, release of vapors of benzenes, toluenes, and xylenes into the environment is reduced or eliminated, and whereby a reduced energy input is required for the continuous process. As a consequence in the process, under normal operating conditions, 95% to 99.9% of benzenes, toluenes, and xylenes separated from the natural gas are contained from the environment and are either used as fuel or processed for sale.

Optionally, the continuous process includes a step of continuously flowing the vapor through an air cooled heat exchanger and inducing or forcing ambient air through the heat exchanger with a fan driven by a hydraulic motor.

Optionally, the continuous process includes operatively driving the hydraulic motor with a portion of the water-rich glycol stream from the step of counter-current contacting.

Optionally, the continuous process includes sensing a temperature of ambient air, and using the sensed temperature to control the portion of the water-rich glycol stream from the step of counter-current contacting.

Optionally, the continuous process includes continuously flowing the vapor through a condenser comprising a heat exchanger, wherein the heat exchanger is in fluid communication with a conduit carrying water-rich glycol from the step of counter-current contacting, and using the water-rich glycol as a cooling and condensing medium in the heat exchanger to condense the vapor of the second stream to form the condensate.

Optionally, the continuous process includes sensing a temperature of ambient air, and using the sensed temperature to control the portion of the water-rich glycol stream from the step of counter-current contacting.

### BRIEF DESCRIPTION OF THE DRAWINGS

The foregoing aspects and many of the attendant advantages, of the present technology will become more readily appreciated by reference to the following Detailed Description, when taken in conjunction with the accompanying simplified drawings of exemplary embodiments. The drawings, briefly described here below, are not to scale, are presented for ease of explanation and do not limit the scope of the inventions recited in the accompanying patent claims.

FIG. 1 is a process flow diagram depicting the major process equipment in a prior art system.

FIG. 2 is a process flow diagram illustrating an example of an embodiment of the continuous process for dewatering natural gas and reducing or eliminating release of benzenes, toluenes and xylenes into the environment.

FIG. 3 is a process flow diagram illustrating another example of an embodiment of the continuous process for dewatering natural gas and reducing or eliminating release of benzenes, toluenes and xylenes into the environment

### DETAILED DESCRIPTION OF EXEMPLARY EMBODIMENTS

The following non-limiting detailed descriptions of examples of embodiments of the invention may refer to appended Figures and are not limited to the drawings, which are merely presented for enhancing explanations of features of the technology. In addition, the detailed descriptions may refer to particular terms of art, some of which are defined herein, as appropriate and necessary for clarity.

The term “raw natural gas” refers to produced natural gas that includes water, whether as entrained minute droplets or as water vapor, that must be removed. The gas may also contain BTX.

The term BTX or BETX refers to “benzenes, toluenes, and xylenes” that are produced along with natural gas from subterranean formations.

The term “reduction or elimination of benzenes, toluenes, and xylenes” means that the process and apparatus are designed to contain or combust the benzenes, toluenes, and xylenes from natural gas such that the benzenes, toluenes, and xylenes emitted into the atmosphere, under normal operating conditions, is zero or that 95% to 99.9% of benzenes, toluenes, and xylenes separated from the natural gas are contained from the environment.

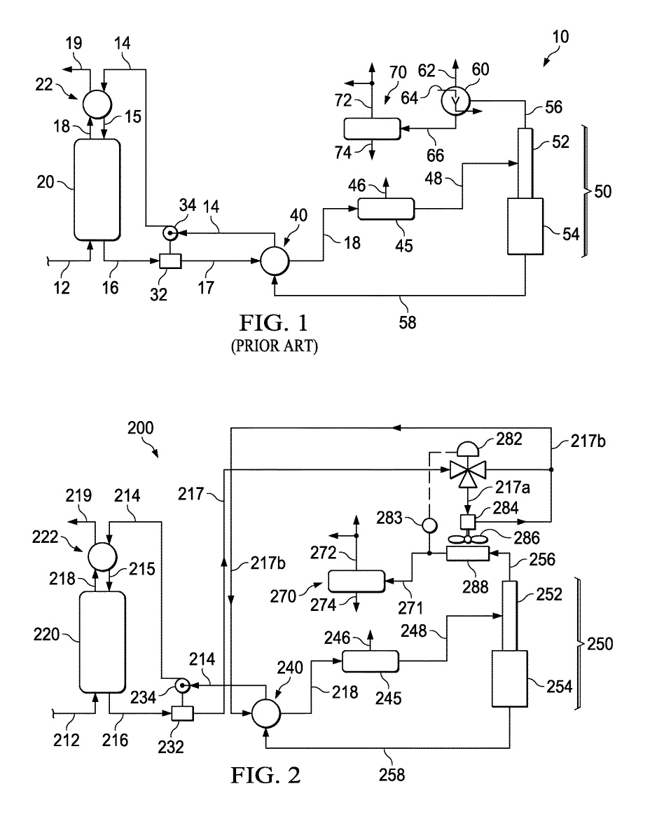

Exemplary embodiments of a continuous process apparatus for removing water from raw natural gas and reducing or eliminating the release of BTX into the environment include energy conservation features as well. Accordingly, as compared to the prior art of FIG. 1, the exemplary embodiments of the inventive technology have significant advantages in both the environmental protection and the energy conservation areas. Moreover, existing equipment may be retrofitted to include the inventive technologies.

In an exemplary embodiment illustrated in FIG. 2, as explained in more detail here below, the energy of a high pressure process stream is used to drive a hydraulic motor that powers a fan. The fan is used as a forced air or induced air fan to push or drag ambient air through a condenser for a stream of vapor that includes steam and BTX, to both cool and completely condense the vapor. By “completely condense,” we understand that there will be some vapor in equilibrium with the condensate, when the condensate is charged to a condensate holding container, and the relative concentrations of each of the components of the equilibrium vapor will be in chemically-related proportion to the concentration of the component in the condensate. Condensation of the BTX vapor along with the water-condensate reduces or eliminates release of the BTX into the environment; the water and liquefied BTX being immiscible can be separated as aqueous and hydrocarbon phases, and the separated BTX can either be sent to storage for subsequent sale, or used as combustion fuel in the natural gas treatment process. Moreover, by using a hydraulic-powered fan and an air cooled heat exchanger, the exemplary embodiment reduces energy consumption by not requiring electricity, which must be generated on site in remote locations. In addition, by eliminating the water cooler condenser 60 of the prior art, there are savings in terms of chemicals for water treatment, and running costs of the water treatment system and pump(s). Accordingly, the system has reduced costs of energy, equipment and chemicals, and is more environmentally friendly in that it reduces or eliminates BTX emissions.

In the process illustrated in FIG. 2, the raw natural gas in line 212 is treated and compressed to exit the process as de-watered, compressed natural gas in stream 226. The water removed from the natural gas is sent to safe disposal. Any BTX removed from the raw natural gas is recovered and may be used as fuel in the process, or may be sold. In more detail, the raw natural gas in line 212 enters near the base of an absorption tower 200, while glycol in line 214, having been cooled in glycol cooler 222 against exiting (dried) natural gas in line 218, enters at the top of the absorption tower 200. In the absorption tower 200 there is counter-current contact between the incoming raw natural gas and the glycol. This contact allows the glycol to strip water out of the raw natural gas to produce a dry natural gas that exits from the top of tower 200 in line 218. The glycol also picks up BTX from the natural gas. The dried gas in line 218 is relatively cooler, and heat is transferred to the gas from the incoming (warmer) glycol (in line 214) in glycol cooler 222. Thus, cooled glycol exits the glycol cooler 222 in line 215 and is routed to the top of absorption tower 200, while dried natural gas exits the glycol cooler 222 in line 219 for routing to storage, transportation, and/or sale.

On the “glycol-handling and BTX-removal” side of the process apparatus, the glycol is dewatered and put in condition for recycling to the absorption tower 200. Upon exiting from near the base of absorption tower 200 in line 216, the glycol, which is under pressure, drives a hydraulic motor 232, which in turn drives the glycol transfer pump 234 that pumps the glycol to the absorption tower 200. The glycol exits the hydraulic motor 232 in line 217, and is routed under control of a control valve 282 either to a glycol preheat exchanger 240, or to the hydraulic drive motor 284 of a fan 286 of an air-cooled heat exchanger 288. The air-cooled heat exchanger 288 is a condenser for distillate vapors from the top of distillation column 252, in line 256. In some circumstances, such as in winter, when ambient temperature conditions are cold, such that condensation can take place in the air cooled heat exchanger without need for the hydraulic fan to operate, the fan is not operated. Thus, a temperature sensor-controller 283 senses the temperature of the condensate and controls the control valve 282 to direct an appropriate amount of glycol to drive the fan motor 284 to ensure complete condensation. The condensate is routed via conduit 271 to the condensate collection drum 270, which contains both the condensed steam (water) as well as condensed (liquid) BTX. The liquid BTX may be separated from the water and routed to sales or for use as fuel in the process. BTX being immiscible with water, the separation of the lighter BTX phase floating on the water phase is relatively straightforward. For safety, the condensate drum 270 is equipped with a vent system 272 that might vent any BTX vapor to a flare system (not shown). Thus, in normal continuous operations, no BTX escapes into the environment from the overheads system of the distillation column 252. Liquid water may be drained from the drum 370 from conduit 374 for disposal. The glycol exiting the fan drive motor 284 in conduit 217 is routed to the glycol preheat exchanger 240. In the glycol preheat exchanger 240, the glycol is heated by taking heat from hot (de-watered for recycling) glycol in line 258, that has been heated in the reboiler 254, as explained later. The heated glycol exits the glycol preheat exchanger 240 in line 218 and is charged to a flash separator 245. Here, BTX entrained in the heated glycol flashes off as vapor in line 246, and can be routed for use as fuel in the process, for example as heating fuel for the reboiler, or to a flare system. The liquid fraction exiting the flash separator 245 is charged to a glycol de-watering combination apparatus 250 that includes a reboiler 254 and a distillation column 252. The combination apparatus 250 separates the glycol from the water it absorbed in absorption tower 220 from the raw natural gas. Thus, de-watered glycol exits in line 258 from the base of the reboiler 254, which is heated by natural gas. The water removed water from the glycol, now in the form of steam, exits in line 256 from the top of the distillation column 252 along with residual volatiles, such as BTX vapor. The steam and BTX vapor in line 256 enters an overheads condenser 288, as described above. The condensate enters an overheads drum 270 that has a vent 272 for releasing non-condensable gasses and BTX to flare. The liquefied BTX can be separated from liquid water (condensate) in drum 270 and routed for sale or for use as fuel in the process. Thus, the system reduces or effectively eliminates emissions of BTX to the environment, and by using the pressure of the glycol as the energy to drive the fan motor, the system also conserves energy.

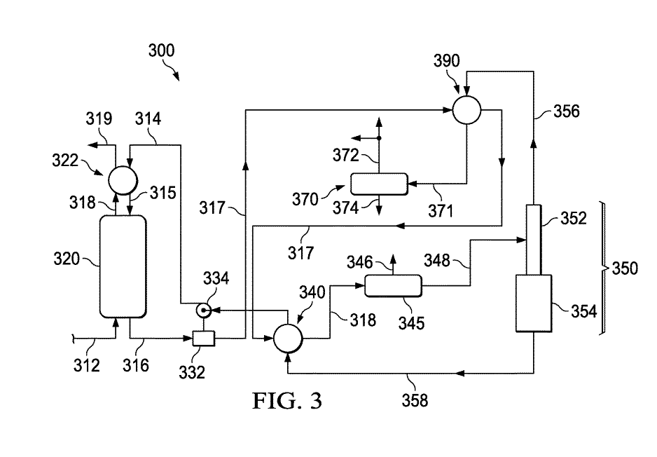

In the exemplary embodiment illustrated in FIG. 3, as explained in more detail here below, the energy of a high pressure water-rich glycol process stream is used to cool and condense a vapor stream from a distillation column that includes steam and BTX to produce complete condensation of the vapor stream to water and liquefied BTX, that may be sold or used as fuel in the process. This system eliminates the need for a water-cooled condenser, along with its costs for water treatment chemicals and pumping. Further, by transferring heat and latent heat of condensation of the vapor stream into the water-rich glycol process stream, this stream is heated up. As a consequence less energy must be added to the reboiler to heat up this stream when it enters the reboiler. Therefore, less fuel must be used to heat the reboiler. Accordingly, the system has reduced costs of energy, equipment and chemicals, reduces or eliminates BTX emissions, and is more environmentally friendly. Indeed, under normal operating conditions, 95% to 99.9% of benzenes, toluenes, and xylenes separated from the natural gas are contained from the environment and are either used as fuel or processed for sale.

Referring to FIG. 3, the raw natural gas in line 312 is treated in a counter-current de-watering absorption process with glycol and then compressed to exit the process as de-watered, compressed natural gas in stream 326. The water removed from the natural gas, and any BTX removed, is directed to further processing for glycol recovery for recycle, and BTX removal. In more detail, the raw natural gas in line 312 enters near the base of an absorption tower 300, while glycol in line 314, having been cooled in glycol cooler 322, enters at the top of the absorption tower 300. In the absorption tower 300 there is counter-current contact between the incoming raw natural gas and the glycol. This contact allows the glycol to strip water out of the raw natural gas to produce a dry natural gas that exits from the top of tower 300 in line 318. The gas in line 318 is relatively cool, and can take up heat from the incoming (warmer) glycol (in line 314) to cool the glycol, in the glycol cooler 322. Thus, cooled glycol exits the glycol cooler 322 in line 315 and is routed to and enters the top of absorption tower 300, while warmed, de-watered natural gas exits the glycol cooler 322 in line 319 for routing to storage, transportation, and/or sale.

On the “glycol-handling and BTX-removal” side of the process apparatus, the glycol is dewatered and put in condition for recycling to the absorption tower 300. Upon exiting from near the base of absorption tower 300 in line 316, the glycol which is under pressure, drives a hydraulic motor 332 which in turn drives the glycol transfer pump 334 that pumps the glycol to the absorption tower 300. The glycol exits the hydraulic motor 332 in line 317, and is routed to a counter-current heat exchanger condenser 390 to condense vapor exiting the top of distillation column 352. The condensate which includes condensed steam and volatile hydrocarbons, such as BTX, is routed via conduit 371 to the condensate collection drum 370. Drum 370 contains both the condensed steam (water) as well as condensed (liquid) BTX. Liquid BTX can be separated from the water condensate because of the immiscibility of BTX in water. The separated BTX may be sold or used as fuel in the process. For safety, the condensate drum 370 is equipped with a vent system 372 that might vent any BTX vapors to a flare system (not shown). Thus, no BTX escapes into the environment from the overheads system of the distillation column 352. Liquid water may be drained from the drum 370 from conduit 374 for disposal. The heated glycol exits the condenser 390 in conduit 317 and is routed to the glycol preheat exchanger 340. The further heated glycol exits the glycol preheat exchanger 340 in line 318 and is charged to a flash separator 345. Here, some BTX entrained in the heated glycol flashes off as vapor in line 346, and can be routed for use as fuel in the process, for example as heating fuel for the reboiler, or to a flare system. The liquid fraction exiting the flash separator 245 in line 348 is charged to a glycol de-watering combination apparatus 350 that includes a reboiler 354 and a distillation column 352. The combination apparatus separates the glycol from the water it absorbed in absorption tower 320 from the raw natural gas. It uses less energy than in the prior art because whereas in the prior art apparatus heat in the condensate is removed into water in a water-cooled condenser 60, in the exemplary embodiment the heat of condensation on cooling is recovered in the condenser 390 into the glycol being charged to the reboiler-distillation column combination 350 in conduit 318. Thus, the glycol in conduit 318 is hotter and less fuel needs to be added to reboiler 354 to effect de-watering. De-watered glycol exits the reboiler-distillation column combination 350 in line 358 from the base of the reboiler 354, and the removed water, in the form of steam, exits in line 356 from the top of the distillation column 352 along with volatiles, such as BTX. The steam and BTX in line 356 enters an overheads condenser 390, as described above. The condensate enters an overheads drum 370 that has a vent 372 for releasing non-condensable gasses and BTX to flare. Thus, the system reduces or effectively eliminates emissions of BTX to the environment, and by recovering the heat otherwise lost from condensate cooling and condensing, it requires less fuel to the reboiler, thereby conserving energy. Under normal operating conditions, 95% to 99.9% of benzenes, toluenes, and xylenes separated from the natural gas are contained from the environment and are either used as fuel or processed for sale.

In an exemplary process for dewatering natural gas and reducing or eliminating release of benzenes, toluenes and xylenes into the environment, several steps may be included. These steps include:

continuous counter-current contacting of upward flowing natural gas containing water with downward flowing glycol to:

(a) dewater the natural gas by absorbing the water in the glycol, and

(b) remove benzenes, toluenes, and xylenes from the natural gas, to produce a water-rich glycol stream containing benzenes, toluenes, and xylenes, and a substantially water-free natural gas stream;

continuously stripping water from the water-rich glycol stream containing benzenes, toluenes, and xylenes to produce a first stream comprising glycol stripped of water, and a second stream, in vapor form, comprising steam and vapors of benzenes, toluenes, and xylenes; and

continuously condensing the vapor of the second stream to produce a liquid condensate comprising water, and liquefied benzenes, toluenes, and xylenes

whereby, during the process, under normal operating conditions, 95% to 99.9% of benzenes, toluenes, and xylenes separated from the natural gas are contained from the environment and are either used as fuel or processed for sale.

While examples of embodiments of the technology have been presented and described in text and some examples also by way of illustration, it will be appreciated that various changes and modifications may be made in the described technology without departing from the scope of the inventions, which are set forth in and only limited by the scope of the appended patent claims, as properly interpreted and construed.

1. A continuous process apparatus for dewatering natural gas and reducing or eliminating release of benzenes, toluenes and xylenes into the environment, the process apparatus comprising:
an absorption tower configured for continuous counter-current contacting therein of upward flowing natural gas containing water with downward flowing glycol to dewater the natural gas, the absorption tower having an exit stream comprising glycol;
a glycol dewatering unit comprising a reboiler and a distillation column, the unit configured for continuously receiving from the absorption tower, via a conduit, a continuous stream of glycol containing water, the unit configured to remove water from glycol to produce a first stream in a first conduit exiting from the reboiler containing glycol that has a reduced water content, and a second stream in a second conduit exiting from a top of the distillation column that comprises overhead vapor, the overhead vapor comprising benzenes, toluenes, and xylenes;
a condenser in continuous fluid communication with the second conduit to receive the overhead vapor from the distillation column, the condenser comprising an air-cooled heat exchanger, the condenser condensing the received overhead vapor including the benzenes, toluenes, and xylenes to form a condensate;
a fan located to force or induce air to flow through the air-cooled heat exchanger, the fan driven by a hydraulic motor, the hydraulic motor operatively driven by glycol exiting from the absorption tower, the glycol communicated via a third conduit in a controlled amount to the hydraulic motor; and
an overheads drum in continuous fluid communication via a condensate conduit with the condenser to receive and contain the condensate.

2. The process apparatus of claim 1, further comprising a hydraulic glycol transfer pump, the pump driven by a second hydraulic motor, the second hydraulic motor driven by glycol exiting from the absorption tower, the second hydraulic motor downstream of the hydraulic motor driving the fan.

3. The process apparatus of claim 1, further comprising a hydraulic glycol transfer pump, the pump driven by a second hydraulic motor, the second motor driven by glycol exiting from the absorption tower, the second hydraulic motor upstream of the hydraulic motor of the fan.

4. The process apparatus of claim 1, wherein a control valve controls a portion of the glycol exiting from the base region of the absorption tower to communicate via a conduit to the hydraulic motor.

5. The process apparatus of claim 4, further comprising a temperature-sensor controller, the temperature sensor-controller controlling the portion of the glycol exiting from the base region of the absorption tower to communicate via a conduit to the hydraulic motor of the fan to achieve condensation of the benzenes, toluenes, and xylenes included in the overhead vapor.

6. A continuous process apparatus for dewatering natural gas and reducing or eliminating release of benzenes, toluenes and xylenes into the environment, the process apparatus comprising:
an absorption tower configured for continuous counter-current contacting therein of upward flowing natural gas containing water with downward flowing glycol to dewater the natural gas, the absorption tower having an exit stream comprising glycol;
a glycol dewatering unit comprising a reboiler and a distillation column, the unit configured for continuously receiving from the absorption tower, via a conduit, a continuous stream of glycol containing water, the unit configured to remove water from glycol to produce a first stream in a first conduit exiting from the reboiler containing glycol that has a reduced water content, and a second stream in a second conduit exiting from a top of the distillation column that comprises overhead vapor, the overhead vapor comprising benzenes, toluenes, and xylenes;
a condenser in continuous fluid communication with the second conduit to receive the overhead vapor from the distillation column, the condenser comprising a heat exchanger, the heat exchanger in fluid communication with a conduit carrying glycol that exited from the absorption column, the heat exchanger configured to utilize the glycol that exited from the absorption column as a cooling and condensing medium to condense the received overhead vapor to form a condensate comprising the benzenes, toluenes, and xylenes; and
an overheads drum in continuous fluid communication via a condensate conduit with the condenser to receive and contain the condensate.

7. The process apparatus of claim 6, further comprising a control valve, the control valve controlling an amount of the glycol in the conduit carrying glycol that exited from the absorption column to the heat exchanger.

8. The process apparatus of claim 7, further comprising a temperature sensor-controller, the temperature sensor-controller controlling the control valve.

9. The process apparatus of claim 6, further comprising a hydraulic glycol transfer pump, the pump driven by a hydraulic motor, the hydraulic motor driven by glycol exiting from the absorption tower, the hydraulic motor downstream of a conduit carrying glycol exiting from the absorption tower to the condenser.

10. The process apparatus of claim 6, further comprising a hydraulic glycol transfer pump, the pump driven by a hydraulic motor, the hydraulic motor driven by glycol exiting from the absorption tower, the hydraulic motor upstream of a conduit carrying glycol exiting from the absorption tower to the condenser.

11. A continuous process for dewatering natural gas and reducing or eliminating release of benzenes, toluenes and xylenes into the environment, the process comprising the steps of:
continuous counter-current contacting of upward flowing natural gas containing water with downward flowing glycol to:
(a) dewater the natural gas by absorbing the water in the glycol, and
(b) remove benzenes, toluenes, and xylenes from the natural gas,
to produce a water-rich glycol stream containing benzenes, toluenes, and xylenes, and a substantially water-free natural gas stream;
continuously stripping water from the water-rich glycol stream containing benzenes, toluenes, and xylenes to produce a first stream comprising glycol stripped of water, and a second stream, in vapor form, comprising steam and vapors of benzenes, toluenes, and xylenes; and
continuously condensing the vapor of the second stream to produce a liquid condensate comprising water, and liquefied benzenes, toluenes, and xylenes;
whereby during the process, under normal operating conditions, 95% to 99.9% of benzenes, toluenes, and xylenes separated from the natural gas are contained from the environment and are either used as fuel or processed for sale.

12. The continuous process of claim 11, wherein the step of continuously condensing the vapor of the second stream comprises flowing the vapor through an air cooled heat exchanger and inducing or forcing ambient air through the heat exchanger with a fan driven by a hydraulic motor.

13. The continuous process of claim 12, further comprising operatively driving the hydraulic motor with a portion of the water-rich glycol stream from the step of counter-current contacting.

13. The continuous process of claim 13, further comprising sensing a temperature of ambient air, and using the sensed temperature to control the portion of the water-rich glycol stream from the step of counter-current contacting.

14. The continuous process of claim 12, wherein the step of continuously condensing the vapor of the second stream comprises flowing the vapor through a condenser comprising a heat exchanger, the heat exchanger in fluid communication with a conduit carrying water-rich glycol from the step of counter-current contacting, and using the water-rich glycol as a cooling and condensing medium in the heat exchanger to condense the vapor of the second stream to form the condensate comprising water, and liquefied benzenes, toluenes, and xylenes.

15. The continuous process of claim 14, further comprising sensing a temperature of ambient air, and using the sensed temperature to control the portion of the water-rich glycol stream from the step of counter-current contacting.

16. The continuous process of claim 11, further comprising the step of separating the water in the liquid condensate from the liquefied benzenes, toluenes, and xylenes.

17. The continuous process of claim 12, further comprising the step of separating the water in the liquid condensate from the liquefied benzenes, toluenes, and xylenes.

18. The continuous process of claim 14, further comprising the step of separating the water in the liquid condensate from the liquefied benzenes, toluenes, and xylenes.
